(19) United States
(12) Patent Application Publication
(10) Pub. No.: US 2006/0282295 A1
(43) Pub. Date: Dec. 14, 2006

(54) Method for providing enhanced risk protection to a grower

(76) Inventors: Shawn James McComb, Algonquin, IL (US); George Bailey Muehlbach, Fort Collins, CO (US); Dermot James Hayes, Ames, IA (US); Bruce Alan Babcock, Ames, IA (US); Claudio J. Martinez, Elgin, IL (US)

Correspondence Address: DEERE & COMPANY, ONE JOHN DEERE PLACE, MOLINE, IL, 61265, US

(21) Appl. No.: 11/248,791

(22) Filed: Oct. 12, 2005

Related U.S. Application Data
(63) Continuation-in-part of application No. 11/149,680, filed on Jun. 9, 2005.

(51) Int. Cl. G06Q 40/00

(52) U.S. Cl. 705/4

(57) ABSTRACT

A method of managing the risk of a grower of a crop comprises obtaining individual risk factor data for growing a particular crop in a grower's field or fields and regional risk factor data for a region associated with grower's field or fields. A data processing system determines a regional risk coverage component for the particular crop for the grower's fields based on an assessment of at least one of the individual risk factor data and the regional risk factor data. An insurer, an agent or another recommends an area-based crop insurance plan to achieve the determined regional risk coverage component. An insurer, an agent or another offers an endorsement or crop insurance policy that covers individual risk of the grower at a premium or rate based on an evaluation of the individual risk factor data.

This application is a continuation-in-part of U.S. App. No. 11/149,680, filed on Jun. 9, 2005.

### FIELD OF THE INVENTION

This invention relates to a method for providing enhanced risk protection to a grower of a crop in the form of crop insurance.

### BACKGROUND OF THE INVENTION

Farmers use group crop insurance to reduce or manage various risks associated with growing crops. Such risks include loss caused by weather, hail, drought, frost damage, insects, or disease, for instance. However, in the United States and some other countries, many group crop insurance policies only pay in the event that a loss reduces an average yield of a particular geographic area (e.g., a county), as opposed to the loss of yield or revenue of an individual grower. Accordingly, farmers have a need for crop insurance to cover the individualized risk of growing crops or a combination of individualized risk and group risk.

### SUMMARY OF THE INVENTION

In accordance with one aspect of the invention, a method for providing risk protection or managing risk for a grower of a crop comprises obtaining individual risk factor data for growing a particular crop in a grower's field or fields and regional risk factor data for a region associated with grower's field or fields. A data processing system determines a regional risk coverage component for the particular crop for the grower's fields based on an assessment of at least one of the individual risk factor data and the regional risk factor data. An insurer, an agent or another recommends an area-based crop insurance plan to achieve the determined regional risk coverage component. An insurer, an agent or another offers an endorsement or crop insurance policy that covers individual risk of the grower at a premium or rate based on an evaluation of the individual risk factor data.

### BRIEF DESCRIPTION OF THE DRAWINGS

FIG. 1 is a flow chart of a first embodiment of a method for providing risk protection for a grower of a crop.

FIG. 2 is a flow chart of a second embodiment of a method for providing risk protection for a grower of a crop.

FIG. 3 is a flow chart of a third embodiment of a method for providing risk protection for a grower of a crop.

FIG. 4 is a flow chart of a fourth embodiment of a method for providing risk protection for a grower of a crop.

FIG. 5 is an illustrative diagram of an insurance product, which may be used to provide a blend of group risk protection and individualized risk protection.

FIG. 6 is a graph that illustrates the targeted risk coverage of supplemental crop insurance.

FIG. 7 is a block diagram of one embodiment of a risk management system.

FIG. 8 is a block diagram of another embodiment of a risk management system.

FIG. 9 through FIG. 13, inclusive, are flow charts of various embodiments of a method for providing risk protection for a grower of a crop.

### DESCRIPTION OF THE PREFERRED EMBODIMENT

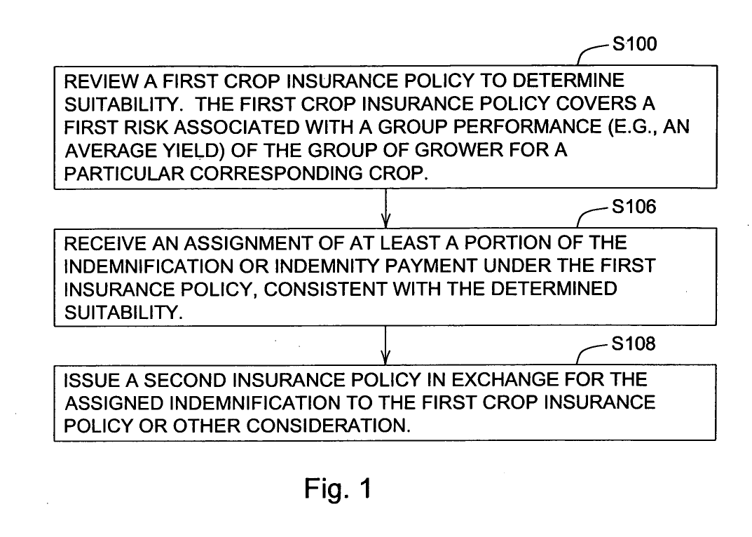

In accordance with one embodiment of the invention, FIG. 1 illustrates a method for providing risk protection for a grower of a crop. The method of FIG. 1 begins in step S100.

In step S100, an insurer, insurance agent, managing general agent or another reviews a first crop insurance policy to determine suitability (e.g., grower eligibility) for association with individualized protection for grower risk. For example, if the first insurance policy or indemnification (e.g., indemnity payment) for group risk is suitable for a partial or complete exchange with crop insurance coverage for individualized risk, the first crop insurance policy may be regarded as suitable.

Step S100 may be carried out in accordance with various techniques, that may be applied alternately or cumulatively. Under a first technique, the first crop insurance generally covers a first risk associated with group performance (e.g., an average yield) or area-based performance (e.g., an area index) of a group of growers for a particular corresponding crop within a defined geographic area (e.g., a county). For example, the first crop insurance policy may cover the risk that group performance (e.g., an average county yield or mean county yield) for a particular crop for the defined geographic area (e.g., a particular county) in which the insured grower grows crops falls below a benchmark group performance (e.g., historic average county yield or historic average county yield performance, possibly adjusted for recent yield trends) or area-based performance for the defined geographic area. Yield trends may consider the impact and degree of adoption of agricultural technological improvements relevant to a particular crop in a defined geographic area. Yield trends may depend upon the adoption rate of certain advanced technologies; improved plant genetics to resist disease and pests; and improved crop inputs to reduce cost of application or to increase effectiveness of application of the crop inputs. Area-based performance may consider a variety of factors or indices that effect crop yield, including, but not limited to, temperature ranges over a time period, maximum temperature over a time period, minimum temperature over a time period, growing degree days, rainfall ranges, maximum rainfall over a time period, or minimum rainfall over a time period, and other weather-related, environmental or climatic factors.

Under a second technique for executing step S100, the first crop insurance policy comprises a Group Risk Protection Policy (GRP). GRP is a risk management tool that protects against widespread loss where yields are generally low within a defined geographic area (e.g., county) in which the grower grows a particular crop. Group Risk Protection (GRP) protects against yield risks that are affected by covered natural disasters (e.g., drought) based on a county yield, instead of a grower's historic yield. The GRP may be preferred by growers with yields that tend to track the county yield and where a drought or other covered nature disaster tends to affect a substantial portion of a county. GRP indemnifies or pays out the insured grower if the county average per acre yield (referred to as the “payment yield”) falls below the insured grower's trigger yield (Y_{T}). Under current practices, the Federal Crop Insurance Corporation (FCIC) notifies or publishes the payment yield to all insurance providers for each county, following each growing season or crop year. The trigger yield (Y_{T}) means the expected county yield (Y_{C}) listed in the actuarial document multiplied by the coverage level percent (C) listed on the accepted application or first crop insurance policy. In other words, the following equation applies Y_{T}=Y_{C}×C, where Y_{T} is the trigger yield, Y_{C} is the expected county yield, and C is the coverage level percent.

The expected county yield may represent an average of annual National Agricultural Statistics Service (NASS) county yields. The NASS county yields may or may not be adjusted for yield trends, as is appropriate under the circumstances or required by laws or other regulations. Under certain policies, the grower may select a coverage level of from approximately sixty percent to approximately one hundred percent of the maximum protection per acre. For a GRP policy as the first crop insurance policy, a grower may have a low yield on his farm and not receive a payment under the GRP policy because the policy is based on county yields, not individual grower yields. The inability of the GRP to provide any individualized risk protection may leave a grower exposed to considerable risk and losses without the supplemental crop insurance and method of this invention.

Under a third technique for executing step S100, the first crop insurance policy comprises a Group Risk Protection Income Protection (GRIP) policy. A Group Risk Income Protection (GRIP) policy is similar to a GRP policy, except the GRIP protects against general loss of revenue in a geographic area (e.g., county), as opposed to general yield shortfall in the geographic area. For example, under a GRIP policy the insured grower may receive a payment from the insurer where the county revenue falls below the insured grower's trigger revenue for the county. For GRIP, under current practices the expected market price is generally set each year or growing season by the U.S.D.A. Risk Management Agency (RMA). For example, the RMA might take an average futures price (e.g., closing prices or final daily settlement prices on the Chicago Board of Trade (CBOT) for a number of business days (e.g., 5 business days) prior to a target date (e.g., March 1 or March 15) for certain crop future contracts (e.g., December corn futures contract and November soybeans contract). For GRIP, the trigger revenue (R_{T}) may be determined in accordance with the following equation: R_{T}=Y_{C}×P_{E}×C, where RT is the trigger revenue (e.g., expressed in revenue/land unit), Y_{C} is the expected county yield, P_{E} is the expected county price, and C is the coverage level in percent. Under a GRIP policy as the first crop insurance policy, when the actual county revenue falls below the trigger revenue, a payment is made to an insured grower in the county, regardless of that grower's revenue. For a GRIP policy as the first insurance policy, a grower may have low revenue on his farm and not receive a payment under the first policy because the policy is based on county revenue, and not individual grower revenue.

Under a fourth technique for executing step S100, the first policy may comprise a GRIP-HRO or its equivalent. GRIP-HRO refers to Group Risk Income Protection with Harvest Revenue Option; and provides some degree of group risk revenue protection based upon growers in a geographic area (e.g., county).

Under a fifth technique for executing step S100, the first risk means a risk associated with a revenue of a group of growers, an average revenue of a group of growers, a revenue per land unit (e.g., dollars per acre of revenue) for the growers associated with geographic area (e.g., a county), or an average revenue per land unit for the growers associated with a geographic area.

In step S106, the insurer receives an assignment of at least a portion of the indemnification or indemnity payment under the first insurance policy, consistent with the determined suitability. For example, the insurer receives an assignment of at least a portion of the indemnification or indemnity payment if the grower is eligible. The assigned portion may range from a portion to all of the indemnification or indemnity payment under the first crop insurance policy. The assigned portion may be defined in terms of one or more of the following, subject to the terms and conditions of the first crop insurance policy, applicable laws, and regulations: (1) an assigned percentage of the indemnification or indemnity payment of the first crop insurance policy, (2) an assignment of any portion of the indemnity payment coupled with a modification of the trigger yield or portion thereof under a GRP policy, (3) an assignment of any portion of the indemnity payment coupled with a modification of the trigger revenue or portion thereof under a GRIP policy, (4) an assignment of any portion of the indemnity payment associated with a modification of the monetary (e.g., dollar) protection level per land unit (e.g., acre) or portion thereof under the GRP policy based on an average futures price on a futures exchange or commodities exchange or fair market value for the particular crop, (5) an assignment of any portion of the indemnity payment associated with a modification to the monetary (e.g., dollar) protection level or portion thereof per land unit (e.g., acre) under the GRIP policy based on an average futures price or a futures exchange or commodities exchange or fair market value for the particular crop, (6) an assignment of any portion of the indemnity payment associated with a certain number of acres of a particular crop (or portion of a grower's total acres) covered by the GRP policy, the GRIP policy, or another first crop insurance policy and (7) an assigned complete or fractional interest in any indemnity payment received under the first crop insurance policy.

In step S108, the insurer issues a second insurance policy in exchange for the assigned indemnification or assignment of the indemnity payment under the first crop insurance policy. Although the insurer may issue the second insurance policy in consideration for the assigned indemnification or assignment of the indemnity payment, the insurer may issue the second insurance policy for other or additional consideration. The second crop insurance policy covers a second risk associated with an individual performance (e.g., an average yield or individual revenue) of an individual grower within the group of growers for the defined geographic area (e.g., a county).

The desired level of protection under the second crop insurance policy may be based upon a particular grower's historic yield, another analysis of historic grower performance, or an analysis of future grower performance. The grower's historic yield may be defined in terms of a grower's actual production history (APH).

The second insurance policy may have, but need not have, any of the following features of a Multiple Peril Crop Insurance (MPCI) program, or its equivalent, as described in this paragraph, or otherwise then in effect. An MPCI policy protects against yield risk of an individual grower that are affected by natural disasters. Catastrophic Risk Protection (CAT) is generally the lowest level of MPCI coverage. MPCI and other policies based on Actual Production History (APH) may, but need not, have the following coverage exclusions: (1) hail and fire exclusion provisions and (2) high risk land exclusion provisions. MPCI and other policies based on APH may have, but need not have, the following coverage requirements or limitations: (1) late planting provisions, (2) replant requirements, (3) replanting payment provisions, (4) prevented planting provisions, (5) nonstandard classification of growers or particular crop, and (6) grower experience adjustment factors. A gap policy, called crop-hail insurance, can fill the gap for damage that is less than the deductible of a basic MPCI policy. Crop-hail insurance may provide acre-by-acre coverage against hail damage, whereas an MPCI policy may only protect against widespread hail damage that materially affects a grower's overall yield.

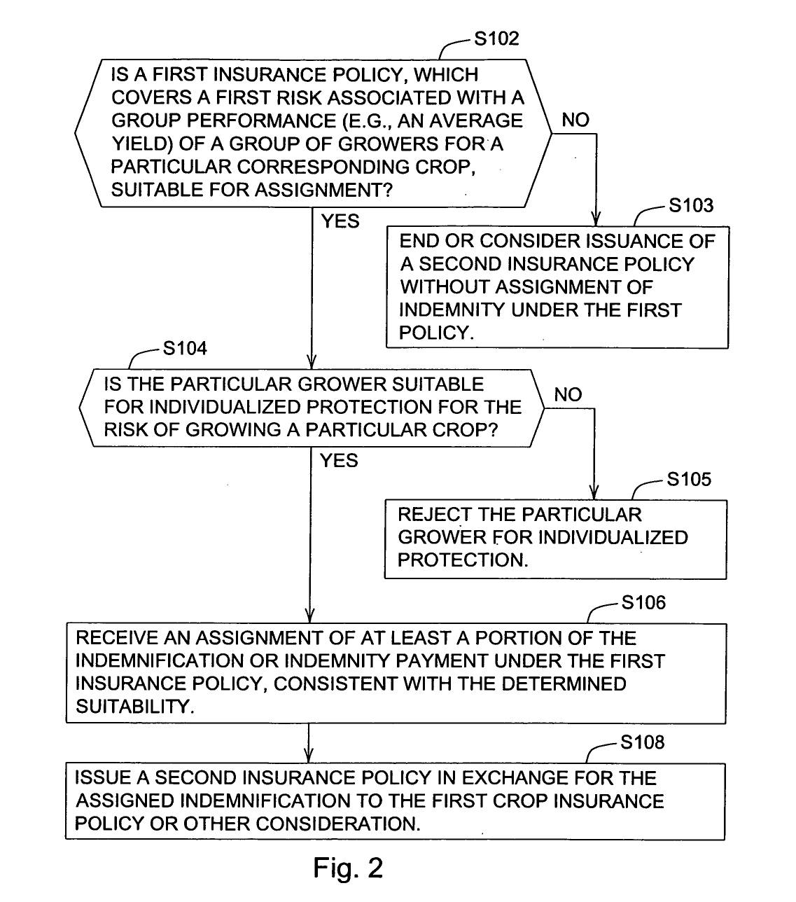

The method of FIG. 2 is similar to the method of FIG. 1, except the method of FIG. 2 replaces step S100 with steps S102, S103, S104, and S105. Like reference numbers in FIG. 1 and FIG. 2 indicate like steps or procedures.

In step S102, the insurer, insurance agent, managing general agent, or another determines whether the first insurance policy is suitable for assignment. The review of the first insurance policy in step S102 may determine one or more of the following factors for suitability of the first crop insurance policy: (1) whether all or part of the indemnification or indemnity payment or indemnity payment of the first crop insurance policy is assignable, and (2) what terms and conditions, restrictions, legal and regulatory requirements apply to assignment of all or part of the indemnification or indemnity payment. For example, the assignment may be unrestricted, restricted to a particular class or group of assignees, or prohibited altogether, depending upon the language of the first insurance policy. For example, unless allowed by the GRP policy, the insured grower cannot insure the same crop through both an MPCI policy and GRP policy. A grower is not generally required to maintain or report yield history for GRP policies. If the first insurance policy is determined to be suitable for assignment, the method continues with step S104. However, if the first insurance policy is determined to be unsuitable for assignment, the method continues in step S103.

In step S103, the method ends or the following alternative is considered. Under the alternative, the issuance of a second insurance policy is considered, where the second insurance policy is without the assignment of indemnity under the first policy. Here, the second policy may be issued for consideration other than the assignment of the indemnity payment under the first crop insurance policy, provided that the first crop insurance policy does not prohibit the grower from securing protection under the first policy (to protect against group risk) and the second policy (to protect against individual risk to an individual grower).

In step S104, the insurer, insurance agent, managing general agent or another determines if the particular grower is suitable for individualized risk protection or a certain level of individualized risk protection based on the particular grower's risk of growing a particular crop in accordance with applicable laws and regulations. The review of step S104 may determine one or more of the following factors for suitability of the particular grower for individualized protection of the grower's risk of growing a particular crop: (1) whether the grower having the first insurance policy has sufficient historic yield data available to predict or estimate future performance applicable to the time frame in which the second crop insurance policy is or would be in effect; (2) whether the grower's historic yield data or historic performance is consistent with a mean historic yield, mode historic yield, or both for a geographic region (e.g., a region of uniform grower or crop performance characteristics) of the group of growers; (3) the degree of variance, if any, between the grower's historic yield data or historic performance relative to the mean historic performance for a particular county or geographic region; (4) genetic makeup or genetic profile of the particular crop to be covered by the second insurance policy, the environment (e.g., geographic area) associated with the grower's fields, and the agronomic management practices of the grower to be covered by the second insurance policy; and (5) the geographic location of one or more of the grower's fields. The above items 1 through 5, inclusive, are merely illustrative examples and other variations may fall within the scope of the method of FIG. 2.

The historic yield data of a geographic region may be publicly available data such as the yield data that is available on a crop-by-crop basis for various counties. For instance, the historic yield data may comprise county yield data of the National Agricultural Statistics Database. The grower seeking insurance coverage may be required to provide historic yield data. The grower-provided historic yield data may be cross-checked against historic yield data for the applicable geographic area to determine if the grower-provided historic yield data is consistent with average yield in the applicable geographic area. Further, the grower-provided historic yield data may be cross-checked against the historic yield data of a reference model grower or a grower located in applicable geographic area or a substantially similar area.

In step S104, the variation of crop yield for a particular grower may depend upon genetic factors, environmental factors, and management practices applied to growing a particular crop. The grower's performance on crop yield may be screened by applying a coefficient of variation (Cᵥ) or another suitable metric for measuring grower performance or the relative performance of two or more growers. For example, the following equation may be used to describe the performance of a particular grower:

$${C}_{V} = \frac{100 σ}{\overline{z}} ,$$

where Cᵥ is the coefficient of variation, σ is the standard deviation of the sample population and \overline{z} is the mean. Further,

$${σ}^{2} = {\sum }_{i = 1}^{n} \frac{{( {z}_{i} - \overline{z} )}^{2}}{n - 1} ,$$

where z₁ through zₙ are samples 1 through n.

The genetic factors may comprise one or more of the following items: plant variety, genetic structure, gene sequences, genetic expression, and DNA (deoxyribonucleic acid) structure of the crop. The genetic factors may influence traits such as drought tolerance, disease resistance, pest resistance, herbicide resistance or tolerance, yield, minimum growing degree days, and period from planting date to harvest date, among other things.

Environmental data may include soil data, soil survey data, weather data, climate data, field boundary data, field location data, or other geographic data on the grower's fields. The soil survey data may include, but is not limited to, the following soil parameters: soil texture, sand content, silt content, clay content, soil structure, bulk density, soil organic matter content, soil moisture, water holding capacity, available water capacity, nitrogen (N) level, phosphorus (P) level, potassium (K) level, nutrient levels, micronutrient levels, trace element levels, mineral levels, soil pH (e.g., level of acidity or alkalinity), and cation-exchange capacity. The available water capacity is the capacity of a soil to hold water available for plants. The available water capacity may be expressed as inches of water per a certain soil depth.

Climate data refers to data on expected long-term weather patterns. Predictive climate data may be based on historical data. Climate data may include precipitation (e.g., rainfall per unit time or rainfall per date of the year), degree days, growing degree days, winds, and temperature statistics for a corresponding geographic area. The temperature statistics may include a minimum temperature, a maximum temperature, a mean temperature, and a mode temperature for a corresponding geographic area. The growing degree day and degree day are both based on temperature statistics. The growing degree day is an index that may be used to express or predict crop maturity. The growing degree day may be based on the minimum and maximum temperature for a day with respect to a reference temperature (e.g., 50 degrees for a corn growing degree day) for a corresponding geographic location. A degree day is used to estimate the amount of energy required to maintain a comfortable target indoor temperature in a certain geographic area. A degree day represents that extent that the daily mean temperature falls below or above an indoor target temperature (e.g., 65 degrees).

Weather data refers to forecasted, current, or historic data concerning the weather associated with a geographic area or location. Weather data may be time stamped, and date stamped. The weather data may include measurements and statistics related to temperature, precipitation, sunlight (e.g., visible or ultraviolet light intensity versus time or cumulative light exposure), cloud cover, wind speed, wind direction, and barometric pressure, for instance.

The management practices of a grower may be rated based on one or more of the following factors, among others: (1) use of a reliable precision guidance system (e.g., Global Positioning System (GPS) receiver with differential correction) for greater efficiency (e.g., reduced fuel consumption) in agricultural tasks (e.g., plowing, planting, tilling, seeding, harvesting, spraying, or applying); (2) use of genetically engineered crops or conventional hybrids in compliance with applicable laws and regulations to increase stress resistance, drought resistance, disease resistance, pest resistances, or reduce chemical inputs; (3) use of preferred crop inputs (e.g., pesticides, fungicides, fertilizer, ammonia, nitrogen) with increased safety, lower human toxicity, greater effectiveness or reduced application amounts to achieve effective result or to comply with laws or governmental regulations, (4) use of low-till or no-till farming operations to reduce soil erosion or loss of applied nutrients during the growing season; (5) use of buffer zones or filter strips to reduce soil erosion or loss of applied nutrients during the growing season, (6) use of crop rotations to reduce pesticide requirements (e.g., dosage or application rates) over a multi-year time span; (7) use of legumes to enrich soil with nitrogen for subsequent crops (e.g., corn or wheat); and (8) the use of organic growing practices (e.g., consistent with the Organic Food Production Act of 1990, 7 U.S.C.§§ 6501-6522). For instance, organic growing practices may prohibit the use of synthetic chemicals during a growing season and for three (3) years immediately preceding the harvest of agricultural products, unless an exception applies under applicable law or regulations. Further organic growing practices may require buffer zones between organically cultivated land and land that is not cultivated in accordance with organic operations.

If the particular grower of the particular crop is determined to be suitable for coverage of individualized risk, the method continues with step S106. However, if the first insurance policy is determined to be unsuitable for coverage of individualized risk, the method continues in step S105. Although step S102 comes priorto step S104 in FIG. 1, it is understood that step S102 and S104 may be executed in any order, including a reversed order from that shown in FIG. 2.

In step S105, the particular grower is rejected for individualized protection for the particular crop.

In step S106, the insurer receives an assignment of at least a portion of the indemnification or indemnity payment under the first insurance policy, consistent with the determined suitability.

In step S108, the insurer issues a second insurance policy in exchange for the assigned indemnification to the first crop insurance policy or other consideration. For example, the premium for the coverage may be based on the desired coverage level (e.g., expressed in percent) multiplied by the currency amount of coverage per land unit (e.g., dollar amount of coverage per acre), less any premium subsidy or governmental subsidy received by the insurer by or on behalf of the grower. The second crop insurance policy covers a second risk associated with an average yield or grower revenue of an individual grower within the group of growers. The desired level of protection may be based upon a percentage of a particular grower's historic yield, for example.

In one example for carrying out step S108, the second insurance policy may define the grower's historic yield in terms of a grower's actual production history (APH). The previous discussion of step S106 and step S108 in FIG. 1 applies with equal force to FIG. 2, as if fully set forth here.

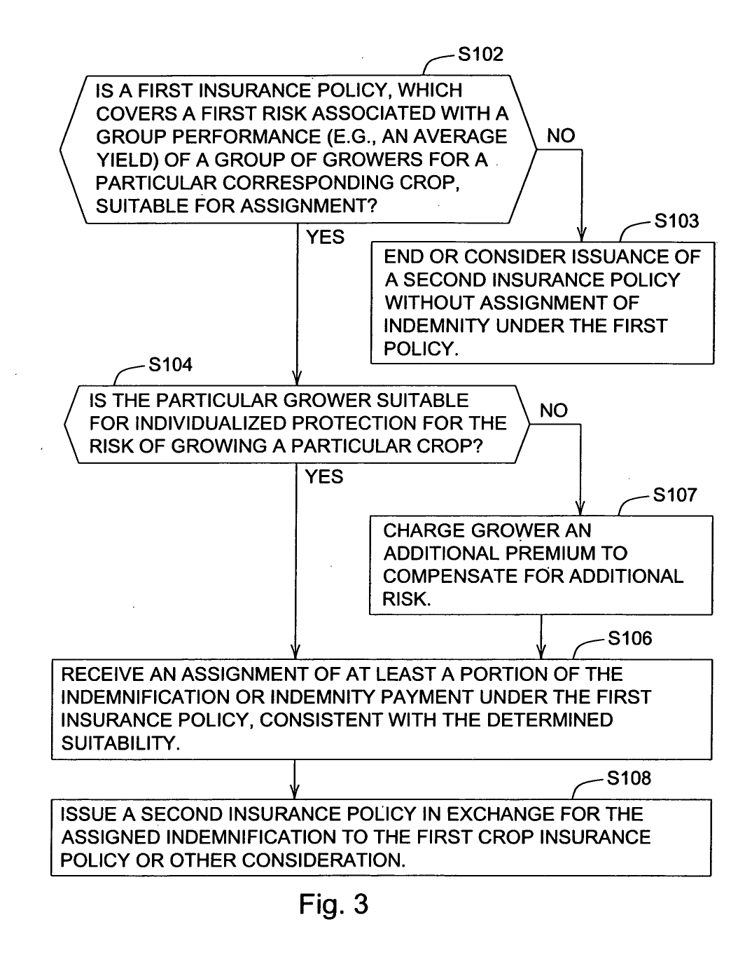

The method of FIG. 3 is similar to the method of FIG. 2, except the method of FIG. 3 replaces step S105 with step S107.

In step S107, the insurer may approve an individual grower for individualized protection under the second insurance policy, if the grower is charged an additional premium (e.g., monetary payment in addition to or instead of the assignment of the indemnity fee) to compensate for additional risk. The amount of the additional premium may be based upon the evaluation of one or more of the factors that are used to determine suitability in step S104, as previously described herein.

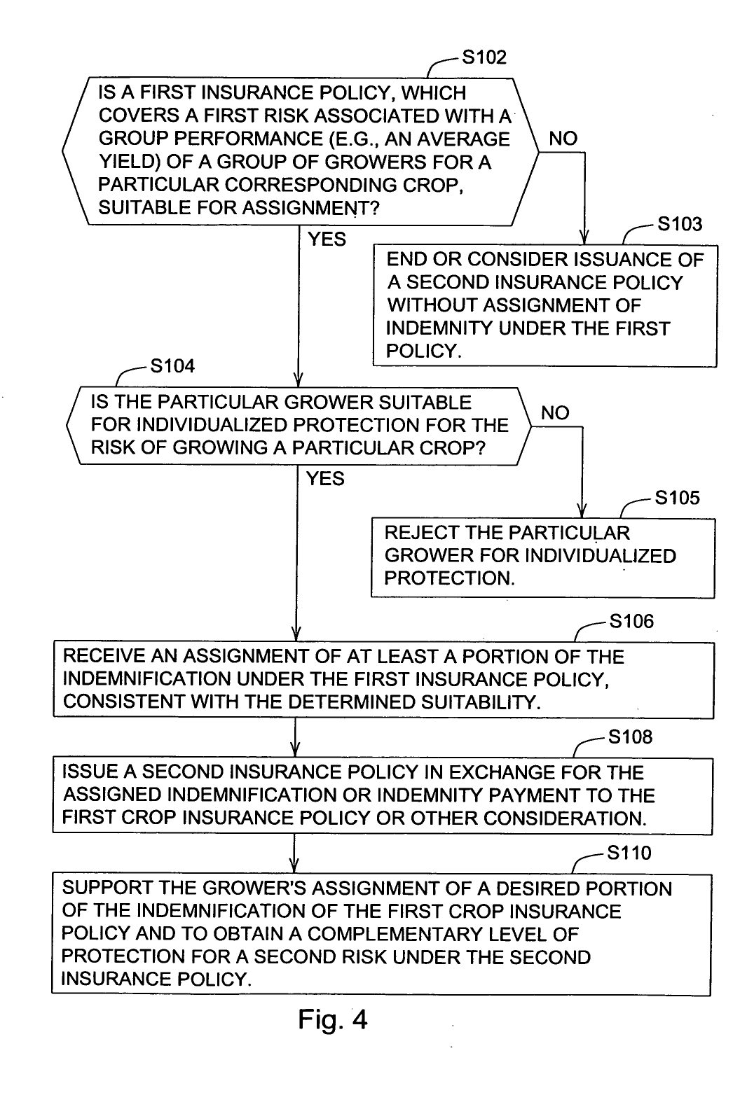

The method of FIG. 4 is similar to the method of FIG. 2, except the method of FIG. 4 further comprises step S110.

In step S110, a grower assigns a desired portion of the indemnification or indemnity payment of the first crop insurance policy to retain a desired level of protection for the first risk (e.g., a group performance risk) under the first crop insurance policy and to obtain a complementary level of protection for a second risk (e.g., individual risk) under the second insurance policy. In the past, growers were not generally permitted to carry a group risk product (e.g., GRP or GRIP) and actual production history crop insurance (e.g., Actual Production History Protection (APHP), Crop Revenue Coverage (CRC), Income Protection (IP) and Revenue Assurance (RA)) for the same growing season and crop, unless an exception was applicable. It is anticipated that a hybrid group-individual risk product (consistent with the method of FIG. 4) may gain wide acceptance in the marketplace for crop insurance and risk management products, subject to approval by crop insurance regulators and as permitted under the contractual terms and conditions of the first crop insurance policy. Here, the hybrid group-individual risk product represents a combination of a partial assignment of any indemnity payment under the first crop insurance policy to cover group risk and the issuance of a second crop insurance policy to cover an individual risk. Accordingly, the grower may receive a first indemnity payment if the county yield falls below the trigger yield and a second indemnity payment if the grower yield falls below a target yield or revenue, for instance. The first indemnity payment and the second indemnity payment are not necessarily mutually exclusive.

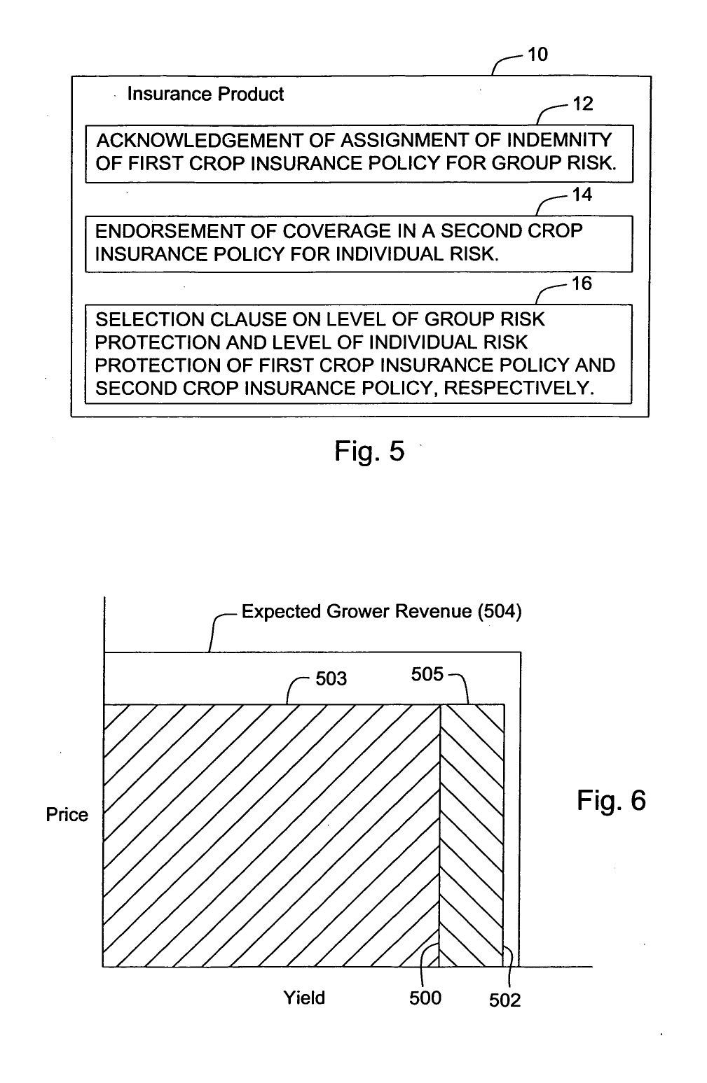

The insurance product of FIG. 5 comprises an acknowledgement of assignment of the indemnity of first crop insurance policy for group risk, an endorsement of coverage in second crop insurance policy for individual risk, and a selection clause on the group level of group risk protection and individual level of individual risk protection of the first crop insurance policy and the second crop insurance policy, respectively. In one embodiment, the acknowledgement 12 of the assignment of the indemnity of the first crop insurance policy relates to an assignment of the indemnity payment to an insurer, an underwriter, or a reinsurer associated with the first crop insurance policy. The endorsement 14 may cover individual risk of a grower growing a particular crop in a manner similar to an MPCI policy, an APH policy, or the like. The endorsement 14 may be based on the grower yield falling below a trigger yield of the individual grower or an actual revenue of the grower for a growing season falling below a trigger revenue. The level of group risk protection may depend upon historic grower performance and whether any additional consideration is received other than assignment of the indemnity payment under the first policy.

FIG. 6 shows an illustrative example of graph of the targeted risk coverage of the first insurance policy and the second insurance policy. Other illustrations of targeted risk coverage may fall within the scope of the method of FIG. 1 through FIG. 5. The horizontal axis of FIG. 6 shows yield of a particular crop and the vertical axis shows crop price of a particular crop. The first crop insurance policy (e.g., GRP crop insurance policy) is associated with a first protection zone 503, which is generally rectangular as illustrated. The second crop insurance policy (e.g., endorsement to the GRP crop insurance policy) is associated with a second protection zone 505, which is adjacent to the first protection zone. The first protection zone 503 and the second protection zone 505 are distinguished by the different cross-hatching in FIG. 6.

A generally vertical line 500, which separates the first protection zone 503 from the second protection zone 505, represents or is generally indicative of the trigger yield that is covered under the first crop insurance policy. A second generally vertical line 502 which forms an outer boundary of the second protection zone 505 represents the greater yield of the grower that is protected under the second crop insurance policy. The second insurance policy coverage covers a gap between the individual grower yield and the county or group yield, such as where the individual yield falls materially below the county or group yield. The expected grower revenue 504 is depicted by the lines outside of the first risk protection zone 503 and the second risk protection zone 505.

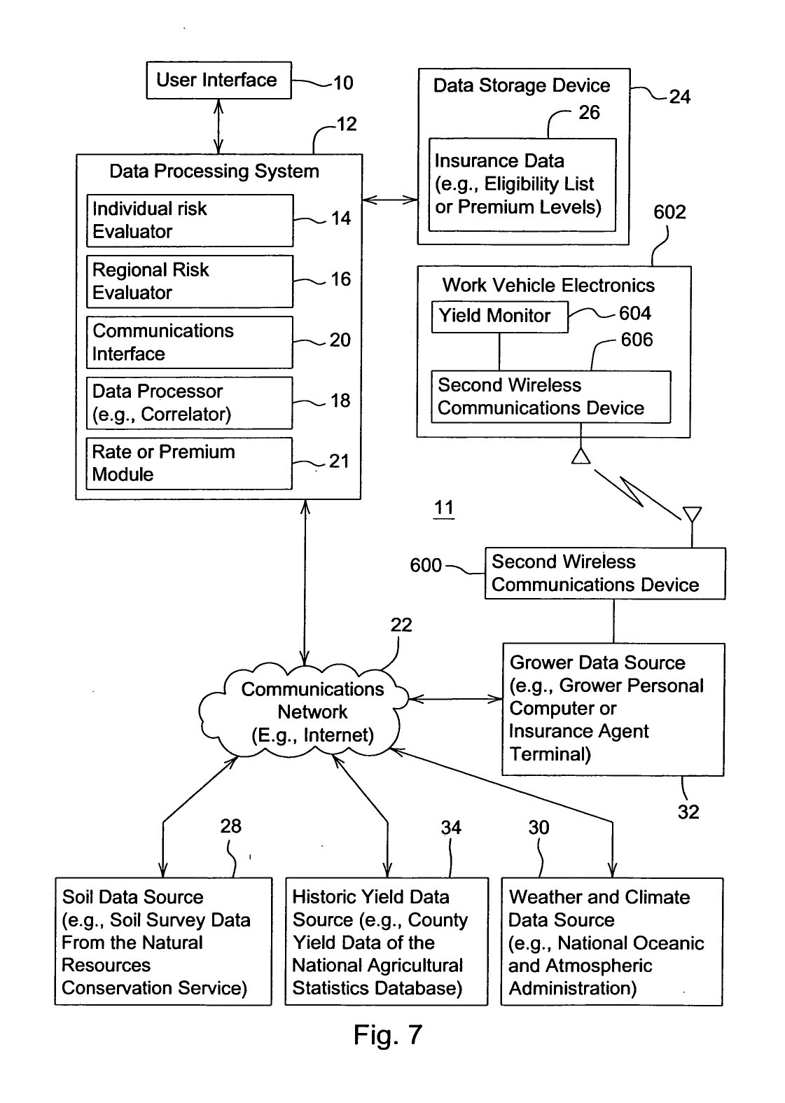

In FIG. 7, the risk management system 11 comprises a data processing system 12 coupled to a user interface 10 and a data storage device 24. The risk management system 11 supports the provision of crop insurance or an endorsement to a crop insurance policy. In one embodiment, the data processing system 12 may communicate with one or more of the following via a communications network 22 (e.g., the Internet): a soil data source 28, a historic yield data source 34, a weather and climate data source 30, and a grower data source 32. Alternately, the user may input data via the user interface 10, where the inputted data is equivalent to, similar to, or distinct from that available via any data source accessible over the communications network 22.

The user interface 10 may comprise any device that enables a user to enter or input data directly or indirectly into the data processing system 12. The user interface 10 may comprise a keyboard, a keypad, a pointing device (e.g., an electronic mouse), a display, an optical drive, a magnetic disk drive, a magnetic reader, or another device for inputting or outputting data.

The data processing system 12 comprises an individual risk evaluator 14, a regional risk evaluator 16, a data processor 18, a rate or premium module 21, and a communications interface 20. The user may enter a particular crop identifier, a particular grower identifier, grower location data, grower field data, grower risk data, individual risk factor data, group risk data, and regional risk factor data via the user interface 10. In one embodiment, the particular crop identifier may provide a reference to the genetic characteristics or genetic profile of the crop or the user may enter the genetic specifications associated with the particular crop.

The individual risk evaluator 14 may estimate the past, present, or future grower performance (e.g., yield) of a particular grower growing a particular crop based on at least one of individual risk factor data and regional risk factor data. The individual risk factor data is associated with growing a particular crop in a grower's field(s), whereas the regional risk factor data is associated with growing the particular crop (or substantially similar crops with respect to genetic composition) in a group of growers' fields. The individual grower performance may be expressed in terms of yield, a yield associated with a respective percentage of reliability or probability, a yield associated with a respective variance, the probability for achieving a corresponding target yield, a probability density function of yield over time, or otherwise. For example, the yield of a particular crop may be expressed in terms of a predicted or estimated bushels per land unit (e.g., acre) or range thereof with a certain percentage of reliability or certainty (e.g., ninety-five percent reliability). The individual risk evaluator 14 may consider one or more of the following individual risk factor data to estimate the performance of a particular crop associated with a particular grower or particular field: historic yield of the particular crop for the particular grower, the crop identifier, genetic profile, or genetic characteristics of the particular crop, historic climate data, historic weather data, soil data, genetic factors for the particular crop, environmental factors for the region or grower's field(s), and crop management factors (e.g., irrigation and application of crop inputs) associated with the particular grower. The individual risk evaluator 14 may consider one or more of the following regional risk factor data to estimate the performance of a particular crop associated with a particular grower in a particular field: historic yield of the particular crop for other growers in the same region (e.g., same county) as the particular grower, historic yield of other growers in substantially similar region (e.g., based on soil characteristics, and climatic characteristics, and weather characteristics) as the particular grower.

The regional risk evaluator 16 may estimate the past, present, or future regional grower performance (e.g., yield) of a particular group of growers growing a particular crop within a region based on regional risk factor data. The region may comprise a county or any geographic area which has substantially similar or homogenous soil characteristics, climatic characteristics, and weather characteristics, or substantially similar yield characteristics for a particular crop. The regional grower performance may be expressed in terms of a group yield, a group yield associated with a respective percentage of reliability or probability, a group yield associated with a respective variance, the probability for achieving a corresponding target yield, a probability density function of group yield over time, or otherwise. The group yield may comprise the aggregate yield of the growers of a particular crop in the region, or an average, mean, or mode.

The data processor 18 may determine the correlation or variance between an individual grower performance and regional grower performance of a particular crop, where the particular grower grows the particular crop in the region. The data processor 18 may determine a regional risk coverage component or regional risk coverage level (e.g., minimum risk coverage level) for the particular grower based on the determined correlation or variance. If the correlation between individual grower performance and regional grower performance meets or exceeds a certain minimum threshold, the grower may seek a first minimum regional risk coverage level of an area-based crop insurance plan. In one illustrative example, the first minimum regional coverage level may be selected to cover a reasonably anticipated loss, potential losses of the grower based on acreage of the particular crop in the region, and/or potential regional yield shortfall (e.g., estimated from recent yield, insect pressure, climate or weather trends, or drought statistics). However, if the correlation does not meet or exceed a certain threshold, the grower's need for individual risk crop insurance may predominate over any requisite regional risk coverage; the grower may seek a second minimal regional risk level for an area-based plan. In one illustrative example, the second minimum regional coverage level is selected to cover catastrophic loss or to otherwise limit the extent of potential loss for the grower within the region. Although the first minimum regional risk coverage level may generally exceed the second minimum coverage level, the actual regional risk coverage level may be selected to exceed the first minimum coverage level, the second minimum coverage level, or both, to facilitate the transfer or assignment of any excess regional coverage indemnity payment in exchange for individual crop insurance coverage. The extent of any requisite individual crop insurance coverage may fall within the business judgment and discretion of the grower.

The communications interface 20 manages communications via the communications network 22. Although the soil data source 28, weather and climate data source 30, historic yield data source 34, and the grower data source 32 are shown as communicating to the data processing system 12 through the communications network 22, any soil data, weather data, climate data, historic yield data, or grower data may be inputted via the user interface 10. That is, the user may input soil data, weather and climate data, historic yield data, grower data, and other input data into the data processing system 12, as opposed to obtaining such input data via the communications network 22 (e.g., Internet).

In one embodiment, the soil data source 28 comprises a server, a database management system, or another data processing system. The soil data source 28 makes available or provides any soil survey data or other soil data from a governmental or nongovernmental entity. For example, the soil survey data may comprise the soil survey data that is available from the National Resources Conservation Service (NRCS) in the United States. Typically, soil survey data is available on a county-by-county basis within each state. Although the scale of soil surveys may vary from county to county, the latest soil survey maps are available in typical scales of 1:12000 or 1:24000. The Natural Resources Conservation Services (NRCS) National Cartographic Center may provide soil maps, text, tables, and spatial data in various text data formats, digital formats, shape files, and other file formats or data structures.

If the soil survey data from government sources does not offer sufficient resolution (e.g., 1 m to 5 m resolution is typical) or if soil survey data in multiple spatial dimensions, commercially available soil surveyors or soil surveying services may collect a database of soil data for a grower, an insurer, or both. Soil survey data may be defined in terms of soil parameters that can affect the performance or growth of a crop.

The soil survey data may include, but is not limited to, the following soil parameters: soil texture, sand content, silt content, clay content, soil structure, bulk density, soil organic matter content, soil moisture, water holding capacity, available water capacity, nitrogen (N) level, phosphorus (P) level, potassium (K) level, nutrient levels, micronutrient levels, trace element levels, mineral levels, soil pH (e.g., level of acidity or alkalinity), and cation-exchange capacity. The available water capacity is the capacity of a soil to hold water available for plants. The available water capacity may be expressed as inches of water per a certain soil depth.

In one configuration, the weather and climate data source 30 comprises a server, a database management system, or another data processing system. The weather and climate data source 30 makes available or provides weather data or climate data available from a governmental or nongovernmental entity. For instance, the weather and climate data may comprise data that is available through the National Oceanic and Atmospheric Administration, the U.S. Department of Agriculture, the National Drought Mitigation Center or other sources. Climate data refers to data on expected long-term weather patterns. Predictive climate data may be based on historical data. Climate data may include precipitation (e.g., rainfall per unit time or rainfall per date of the year), degree days, growing degree days, winds, and temperature statistics for a corresponding geographic area or region. The temperature statistics may include a minimum temperature, a maximum temperature, a mean temperature, and a mode temperature for a corresponding geographic area or region. The growing degree day and degree day are both based on temperature statistics. The growing degree day is an index that may be used to express or predict crop maturity. The growing degree day may be based on the minimum and maximum temperature for a day with respect to a reference temperature (e.g., 50 degrees for a corn growing degree day) for a corresponding geographic location or region. A degree day is used to estimate the amount of energy required to maintain a comfortable target indoor temperature in a certain geographic area. A degree day represents that extent that the daily mean temperature falls below or above an indoor target temperature (e.g., 65 degrees).

Climate data may be used to determine or estimate an average growing season duration for a corresponding geographic area, growing zones suitable for particular crops (e.g., based on the genetic composition of those crops), temperature range zones, or other climate classifications for corresponding geographic areas (e.g., region) that are useful for agronomic management, crop selection, planting dates, and crop maturity estimation.

Weather data refers to forecasted, current, or historic data concerning the weather associated with a geographic area (e.g., region) or location. Weather data may be time stamped, and date stamped. The weather data may include measurements and statistics related to temperature, precipitation, sunlight (e.g., visible or ultraviolet light intensity versus time or cumulative light exposure), cloud cover, wind speed, wind direction, and barometric pressure, for instance.

The weather data may be used to provide a drought assessment or drought report for a corresponding geographic location or area (e.g., region). A drought refers to a deficiency of precipitation resulting from a short term or long-term weather pattern. The drought may be defined with reference to a drought severity index (e.g., Palmer Drought Severity Index, the Crop Moisture Index, and the Z index). A weather forecast may be used to determine the probability of ending or reducing the severity level of a drought in a given geographic area.

The historic yield data source 34 may comprise publicly available data such as the yield data that is available on a crop-by-crop basis for various counties. For instance, the historic yield data may comprise county yield data of the National Agricultural Statistics Database.

The grower data source 32 may comprise a grower personal computer, a grower terminal, or an insurance agent terminal that communicates with the data processing system 12 via the communications network 22. For example, a grower terminal may access the Internet via an internet service provider (ISP) or a wireless Internet link (e.g., WiFi) to complete or submit an application for a crop insurance policy or endorsement to another crop insurance policy.

As shown in FIG. 7, work vehicle electronics 602 are associated with a work vehicle (e.g., combine or harvester for harvesting grain) and communicate to the grower data source 32 via a first wireless communications device 606 and a second wireless communications device 600. The work vehicle electronics 602 comprises a yield monitor 604 and the first wireless communications device 606. In one embodiment, the first wireless communications device 606 and the second wireless communications device 600 each comprise a transceiver for transmitting and receiving an electromagnetic signal in accordance with any modulation scheme (e.g., code division multiple access, time division multiple access, phase shift keying, frequency modulation, amplitude modulation, or otherwise).

The yield monitor 604 comprises a sensing or measurement system associated with a work vehicle for measuring a volume, mass, or weight of a harvested crop and storing the yield data as electronic data for subsequent processing. For example, a particular grower may operate a work vehicle (e.g., combine or harvester) equipped with a yield monitor 604 for monitoring the yield (e.g., in terms of weight, volume, or both) of the harvested crop from the grower's field(s) or portions thereof. The yield data or yield data and corresponding location data is communicated from the yield monitor 602 via an electromagnetic signal transmitted from the first wireless communications device 606 to the second wireless communications device 600. Further, the grower data source may forward or facilitate the provision of the collected yield data to the data processing system 12 for further analysis.

In general, work vehicle electronics 602 may be equipped with a yield monitor 604 that uses a strain gauge (e.g., piezo-electric sensor) or optical sensor to sense the weight or volume of grain flowing through a discharge region (e.g., a grain discharge region) of a work vehicle (e.g., a combine). In one example of a yield monitor 604, a strain gauge or piezo-electric sensor is mounted between an impact plate and a fixed surface of a discharge region of a combine. As the harvested crop (e.g., grain) strikes the impact plate, the piezo-electric sensor is compressed or otherwise deformed, resulting in a measurable change in the voltage or current of a circuit coupled to the piezo-electric sensor, which can be converted into an estimated yield.

In another example of a yield monitor 604, a potentiometer is used to measure the displacement of an impact plate in a grain discharge region. In still another example of a yield monitor 604, a volume of grain passing between a an optical source and a group of photo-detectors is measured to estimate the volume of grain based upon the attenuation versus time or pattern of attenuation versus time in the transmitted light received at one or more photo-detectors.

Alternatively, instead of relying upon a yield monitor 604, the grower may have access to a scale or weighing apparatus (not shown) for weighing a shipping container, trailer, truck or vehicle containing a harvested crop and may manually enter such yield, weight, or mass into the grower data source 32 or the data processing system 12 via a user interface (e.g., user interface 10).

In any embodiment disclosed herein, the grower may provide grower data to the data processing system 12 via a browser, an electronic interview process, or an electronic insurance application or similar document supported by the grower data source 32. Similarly, the grower may in person or via a telecommunications network (e.g., telephone network) provide data to an insurance agent or insurance worker who enters the data into the data processing system 12, directly through the user interface 10 or indirectly through the grower data source 32.

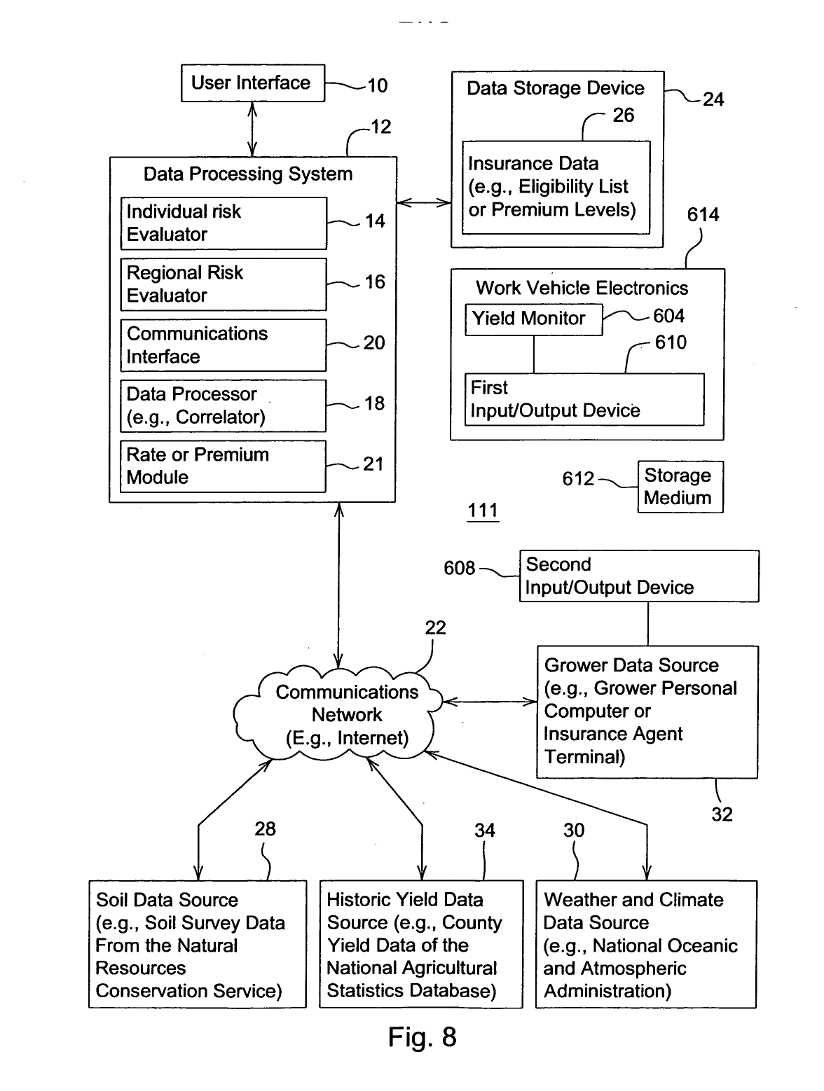

The risk management system 111 of FIG. 8 is similar to the risk management system 11 of FIG. 7, except the first wireless communications device 606 and the second wireless communications device 600 are replaced by the first input/output device 610 and the second input/output device 608. Like reference numbers in FIG. 7 and FIG. 8 indicate like elements.

Each input/output device (608, 610) may be capable of or writing to, or reading from, or both reading and writing to a storage medium 612. Examples of input/output devices (608, 610) include, but are not limited to, optical disk drives, magnetic disk drives, and magnetic tape drives, and ports for communicating with memory (e.g., Flash memory, non-volatile memory, or memory sticks). The storage medium 612 is used to transfer yield data between the work vehicle electronics 614 and the grower data source 32. In turn, the grower data source 32 may provide or make such yield data accessible to the data processing system 12.

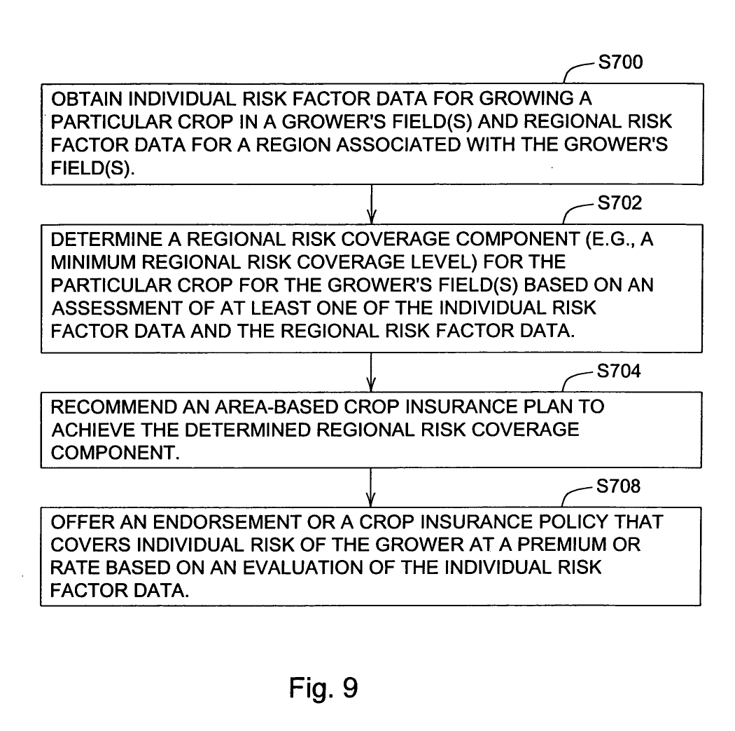

FIG. 9 illustrates a method for providing risk protection for a grower of a crop. The method of FIG. 9 begins in step S700.

In step S700, a data processing system 12 obtains individual risk factor data for growing a particular crop in a grower's field or fields and regional risk factor data for a region associated with the grower's field. For example, the individual risk evaluator 14 obtains individual risk factor data for growing a particular crop in a grower's field or fields and the regional risk evaluator 16 obtains regional risk factor data for a region associated with the grower's field. The region may be defined as the county in which the grower's field or fields are located or another area (other than a county) with substantially similar soil characteristics, climatic characteristics, and weather characteristics to those of the grower's field or fields.

The individual risk factor data may be based on one or more of the following factors for a grower's field or fields: a location or boundaries of the grower's field(s), the soil data or soil characteristics associated with the grower's field(s), the climate data associated with the grower's field(s), the weather data associated with the grower's field(s), the management practices of the grower, the environment of the grower's field(s), the genetic composition or make-up of crops, seeds, or crop precursors grown or planted by the grower, the actual production history of the grower or the grower's field(s), and the historic yield data of the grower of the grower's field(s). The individual risk factor data may be provided or made available via one or more of the following data sources: the soil data source 28, the historic yield data source 34, the weather and climate data source 30, the grower data source 32, and the yield monitor 604.

The regional risk factor data is synonymous with group risk factor data. The regional risk factor data may be based on one or more of the following group risk factors for a group of growers or growers' fields in a region: locations of the growers' field(s), the soil characteristics associated with the growers' field(s), the climate associated with the growers' fields, the weather associated with the growers' fields, the management practices of the growers (e.g., irrigation usage), the environment of the growers (e.g., drainage improvements of the growers' fields), the genetic composition or make-up of crops, or crop precursors grown or planted by the growers, the actual production history of the growers or the growers' fields, and the historic yield data of the growers' fields. The group risk factor data may be expressed as averages, means, or modes of factor values, probability density functions, or otherwise. The regional risk factor data may be provided or made available via one or more of the following data sources: the soil data source 28, the historic yield data source 34, the weather and climate data source 30, and the grower data source 32, and multiple yield monitors 604 of different growers.

In step S700 or prior thereto, one or more growers within the group of growers may operate a work vehicle (e.g., combines or harvesters) equipped with a yield monitor (e.g., 604) for monitoring the yield in terms of weight, volume or both of the grower's fields or portions thereof. The yield monitor (e.g., 604) comprises a sensing or measurement system associated with a work vehicle for measuring a volume, mass, or weight of a harvested crop and storing the yield data as electronic data for subsequent processing. Alternatively, one or more growers within the group of growers may have access to a scale or weighing apparatus for weighing a shipping container, trailer, truck or vehicle for transportation of a harvested crop.

In one example of carrying out step S700, the individual risk factor data and the regional risk factor data may be expressed as yield data, weight data or volume data on the harvested crop that is associated with one or more grower identifiers, growing field identifiers, or geographic identifiers. The yield data, weight data or volume data may be stored together with its respective identifier as electronic data for subsequent processing by a data processing system 12. Further, the yield data, weight data, or volume data may be associated with corresponding reliability levels, probability levels, probability density functions, or other statistical indicators for achieving such yield data, weight data, or volume data for a particular crop in a particular grower's field(s) or group of growers' fields.

In step S702, a data processing system 12 or data processor 18 determines a regional risk coverage component (e.g., a minimum regional risk coverage level) for a particular crop for the grower's fields based on the assessment of at least one of the individual risk factor data and the regional risk factor data. For example, the data processor 18 may determine a minimum regional risk coverage level as a recommendation for a particular grower based on at least one of an individual risk factor data and regional risk factor data.

Step S702 may be carried out as follows in this paragraph, although other alternatives fall within the scope of the method of FIG. 9. If the correlation between individual grower performance and regional grower performance meets or exceeds a certain minimum threshold, the grower may seek a first minimum regional risk coverage level of an area-based crop insurance plan. In one illustrative example, the first minimum regional risk coverage level may be selected to cover a reasonably anticipated loss, potential losses of the grower based on acreage of the particular crop in the region, and/or potential regional yield shortfall (e.g., estimated from recent yield, insect pressure, climate or weather trends, or drought statistics). However, if the correlation does not meet or exceed a certain threshold, the grower's need for individual risk crop insurance may predominate over regional risk; the grower may seek a second minimal regional risk level for an area-based plan. In one illustrative example, the second minimum regional risk coverage level may be selected cover catastrophic loss for the grower within the region. Although the first minimum regional risk coverage level may generally exceed the second minimum coverage level, the actual regional risk coverage level may be selected to exceed the first minimum coverage level, the second minimum coverage level, or both, to facilitate the transfer or assignment of any excess regional coverage indemnity payment in exchange for individual crop insurance coverage. Herein, the minimum coverage level may refer to the first minimum coverage level, or the second minimum coverage level, individually or collectively.

More generally, in any embodiment, the assessment of step S702 may consider the following factors: historic correlation between a particular grower's farm yield and a corresponding regional yield (e.g., county yield) for a particular crop, historic variance between a particular grower's farm yield and a corresponding regional yield a county, a correlation of soil characteristics of the particular grower's field to those of region (e.g., county), correlation of climate characteristics of the grower's field to those of the region (e.g., county), differences or variation in soil characteristics between the particular grower's field and region, differences in elevation (e.g., average height about sea level) between the grower's field and the region, differences in irrigation or drainage between the particular grower's field and typical fields within a region or county, a distance of the grower's field with respect to a geographic center of the region, and distribution of the grower's fields or geographic dispersion of multiple grower fields within the region.

In one example, if the grower's yield of the grower's fields have a generally high correlation to the regional yield of a group of growers in the region (e.g., county), the grower may seek or be receptive to a greater level of regional risk (e.g., greater minimum regional risk coverage level) coverage than individual risk coverage. However, if the grower's fields have a generally low correlation to the regional yield of a group of growers in the region, the grower may seek or be receptive to a greater level of individual risk coverage than regional risk coverage. In the latter case, a lower minimum regional risk coverage level might apply.

In another example, if the grower's soil characteristics of the grower's fields have a generally high correlation to the regional soil characteristics of a group of growers in the region (e.g., county), the grower may seek or be receptive to a greater level of regional risk coverage (e.g., a greater minimum regional risk coverage) than individual risk coverage. However, if the grower's fields have a generally low correlation to the regional soil characteristics of a group of growers in the region, the grower may seek or be receptive to a greater level of individual risk coverage than regional risk coverage. In the latter case, a lower minimum regional risk coverage level might apply.

In another example, if the grower's climatic characteristics of the grower's fields have a generally high correlation to the regional climatic characteristics of a group of growers in the region (e.g., county), the grower may seek or be receptive to a greater level of regional risk coverage (e.g., greater minimum regional risk coverage level) than individual risk coverage. However, if the grower's fields have a generally low correlation to the climatic soil characteristics of a group of growers in the region, the grower may seek or be receptive to a greater level of individual risk coverage than regional risk coverage. In the latter case, a lower minimum regional might apply.

In step S704, a regional crop insurance plan or an area-based crop insurance plan is recommended to achieve the determined regional risk coverage component. For example, the regional crop insurance plan is recommended to achieve a minimum regional risk protection level, consistent with the determination of step S702.

The regional risk coverage component may provide yield coverage or revenue coverage for the particular crop. The regional risk coverage component covers risks associated with a group of growers in a certain region (e.g., a county) or an area with substantially similar climate and substantially similar soil characteristics. For crop insurance, the yield coverage may pay the grower (or its designated assignee or beneficiary) an insurance indemnity payment where the grower falls below a trigger yield, whereas the revenue coverage may pay the grower (or its designated assignee or beneficiary) an insurance indemnity payment if the grower revenue or grower income falls below a certain threshold. Regional or group risk policies may include GRP (Group Risk Protection), GRIP (Group Risk Income Protection), and GRIP HRO (Group Risk Income Protection with Harvest Revenue Option), for example.

In step S708, an endorsement or individual crop insurance policy is offered, where the endorsement or individual crop insurance policy covers the individual risk of a particular grower within the region at a premium or rate based on an evaluation of the individual risk factor data. For instance, in step S708 a rate or premium module 21 may first determine a premium or rate based on an evaluation of the individual risk factor data (obtained in step S700), and second an insurer, agent or another (person or entity) may offer the endorsement or individual insurance policy at the determined premium or rate. The individual risk coverage may provide yield coverage or revenue coverage for the particular crop. The individual risk coverage component covers risks associated with the particular grower or the grower's fields. The grower may select the individual risk coverage level based on its own analysis or the recommendations of an agronomist, consultant, or advisor, for instance.

The grower may attain individual crop insurance protection to address risks that may face the grower disparately with respect to a region. One example of an individual risk component is wind damage, which may affect individual farms differently than a group of farms in a geographic region. Localized insect pressure or localized drought may also cause disparate yields within a region.

The individual risk policy may be analogous to a APH (Actual Production History) crop insurance policy, RA (Revenue Assurance) crop insurance policy, an RA HRO (Revenue Assurance with Harvest Revenue Option), or another insurance policy to protect against individualized risk of the particular grower or the particular grower's field. In the U.S., the endorsement may comprise a private endorsement of a federal, area-based insurance plan supported by the Risk Management Agency, the U.S. Department of Agriculture, or another governmental entity or agency. The RA or APH may be adjusted based on expected yield trends, which may be generally higher than historical average yields (e.g. typically used in federal crop insurance).

In one embodiment, the rate or premium module 21 may determine the premium that the grower pays for the individual risk component may be determined based on a difference between a total premium and a fair value of the surrender or assignment of all or at least a portion of the indemnity payment of the area-based plan, as the case may be. The total premium includes the sum of the regional component premium and the individual component premium.

In accordance with the method of FIG. 9, the grower may achieve hybrid protection that protects against both regional and individual risks in a desired ratio or in equivalent percentage terms. The grower is better able to reduce risks based on the grower's location, track record, management practices, and environment.

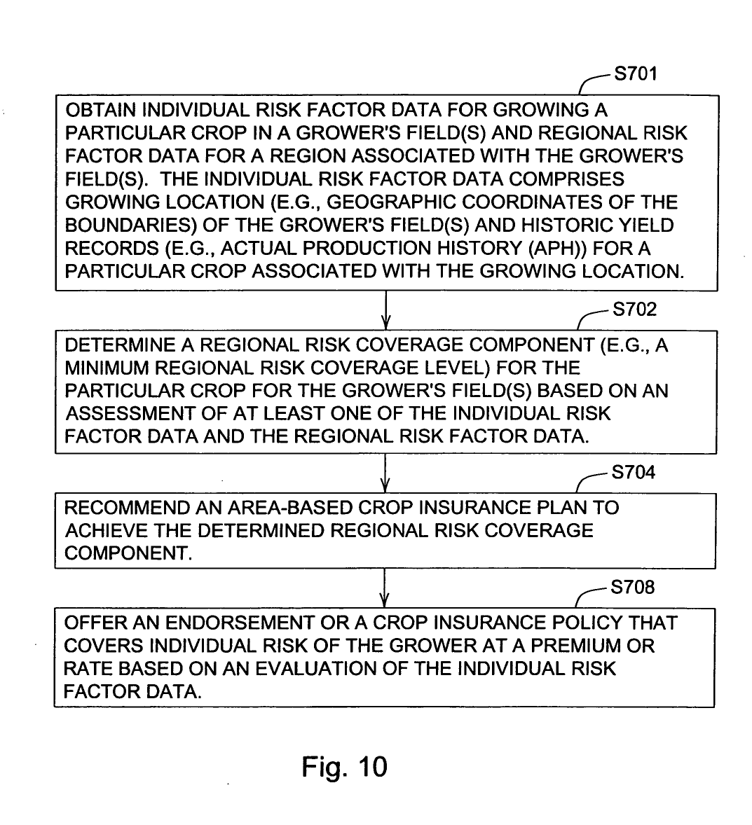

The method of FIG. 10 is similar to the method of FIG. 9, except step S700 of FIG. 9 is replaced by step S701 of FIG. 10. Like reference numbers in FIG. 9 and FIG. 10 indicate like procedures or steps.

In step S701, the data processing system 12 obtains individual risk factor data and regional risk factor data for a region associated with the grower's fields, where the individual risk factor data comprises growing location(s) of the grower's field(s) and historic yield records (e.g., Actual Production History (APH)) for a particular crop associated with the growing location.

The growing location of the grower's fields may be obtained in accordance with various techniques, which may be applied individually and cumulatively. In accordance with a first technique of executing step S701, a person or vehicle (e.g., with the grower's consent) traverses a boundary of the grower's fields, while collecting location data and recording it in a storage medium. The growing location data may comprise a series of points that lie on the boundary of one or more of the grower's fields. A location-determining receiver (e.g., Global Positioning System (GPS) receiver with differential correction may be used to collect the growing location data.

In accordance with a second technique, a person or data processing system may retrieve a legal description of grower fields from real property records, a real property survey, a property deed, or otherwise. Further, the data processing system may convert the legal description (e.g., in meets and bounds) to a series of geographic coordinates, or another data structure (e.g., a shapefile). A shapefile provides a data structure for storing non-topographical geometry and spatial features, where the geometry is typically stored as vector coordinates. Spatial features may comprise points, lines, curves and area features. Area features may be stored as digitized polygons.

With regards to the collection of historic yield data in step S701, the historic yield data may be obtained in accordance with various procedures that may be applied collectively or individually. Under a first procedure, the grower may use a harvester, combine, or other work vehicle equipped with a yield monitor 604. Under a second procedure, the grower or another person may weigh or measure the weight or volume of the harvested crop via a scale, or volumetric measuring device. For example, the harvested grain is transported to a truck scale (e.g., at a grain elevator), where it is unloaded.

Under a third procedure, annual National Agricultural Statistics Service (NASS) county yields records are accessed to estimate a grower's yield from a county yield. The NASS county yield itself may be synonymous with, or at least indicative of, a regional yield or regional risk factor data. The NASS county yields may or may not be adjusted for yield trends, as is appropriate under the circumstances or required by laws or other regulations.

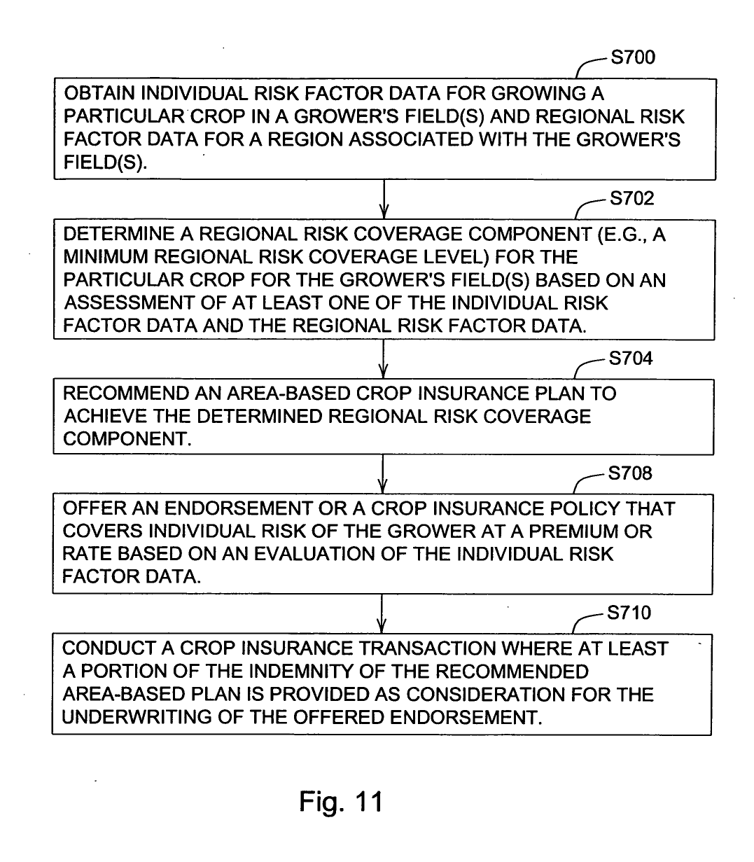

The method of FIG. 11 is similar to that of FIG. 9, except the method of FIG. 11 further comprises step S710. Like reference numbers in FIG. 9 and FIG. 11 indicate like procedures or steps.

As illustrated, step S710 may be carried out after step S708. In step S710, a crop insurance transaction is conducted where at least a portion of an indemnity payment or the contractual right to receive such insurance indemnity payment (for the area-based crop insurance plan) is assigned or transferred as consideration for the underwriting or issuance of an individual crop insurance policy or individual endorsement for a particular grower. For example, the grower may assign all of the indemnity or merely a portion of the indemnity payment of a GRP, GRIP, GRP HRO crop insurance policy, a regional crop insurance plan, a group crop insurance plan, or another area-based crop insurance policy to an insurer or a designee of an insurer.

Step S710 may be carried out in accordance with various techniques that may be applied separately or cumulatively. In accordance with a first technique, all of the indemnity payment of the recommended area-based plan or regional insurance plan is assigned or transferred to an insurer in exchange for that insurer issuing the offered endorsement or offered individual insurance policy. Here, the area-based crop insurance plan may have a coverage level selected to meet a minimum regional risk coverage level. Further, under the first technique, the grower may procure the recommended area-based crop insurance plan or another area-based crop insurance plan with a value (e.g., surrender value) that is less than or equal to the requisite premium to cover the grower's individual risk. If the surrender value of the area-based plan is equal to the requisite premium for an individual crop insurance policy, the grower may assign all of the indemnity payment of the area-based crop insurance plan in exchange for the individual insurance policy. However, if the surrender value of the area-based plan is less than the premium of the individual crop insurance policy, the grower may be required to make an additional payment to cover the applicable premium for the individual crop insurance policy.

In accordance with a second technique, a portion of the indemnity payment of the recommended area-based crop insurance plan or regional insurance plan is assigned or transferred to an insurer in exchange for that insurer issuing the offered endorsement or offered individual insurance policy. Here, the grower may procure the recommended area-based crop insurance plan or another area-based crop insurance plan with a value (e.g., surrender value) that is greater the requisite premium to cover the grower's individual risk. Accordingly, the grower may pay no additional premium for the individual crop insurance policy or individual endorsement and may retain some regional risk protection associated with a retained or unassigned indemnity payment. Alternatively, the grower may pay additional premium for an increased level of protection or coverage under the individual crop insurance policy or endorsement.

In accordance with a third technique, a portion of the indemnity payment of the recommended area-based insurance plan or regional insurance plan exceeding a minimum regional risk coverage level is assigned or transferred to an insurer in exchange for that insurer issuing the offered endorsement or offered individual insurance policy.

In accordance with a fourth technique, a portion of the indemnity payment of the recommended area-based insurance plan or regional insurance plan exceeding a minimum regional risk coverage level is assigned or transferred to an insurer, along with a monetary payment, proceeds from secured loan, proceeds from a unsecured loan or funds associated with a promissory note, in exchange for that insurer issuing the offered endorsement or offered individual insurance policy.

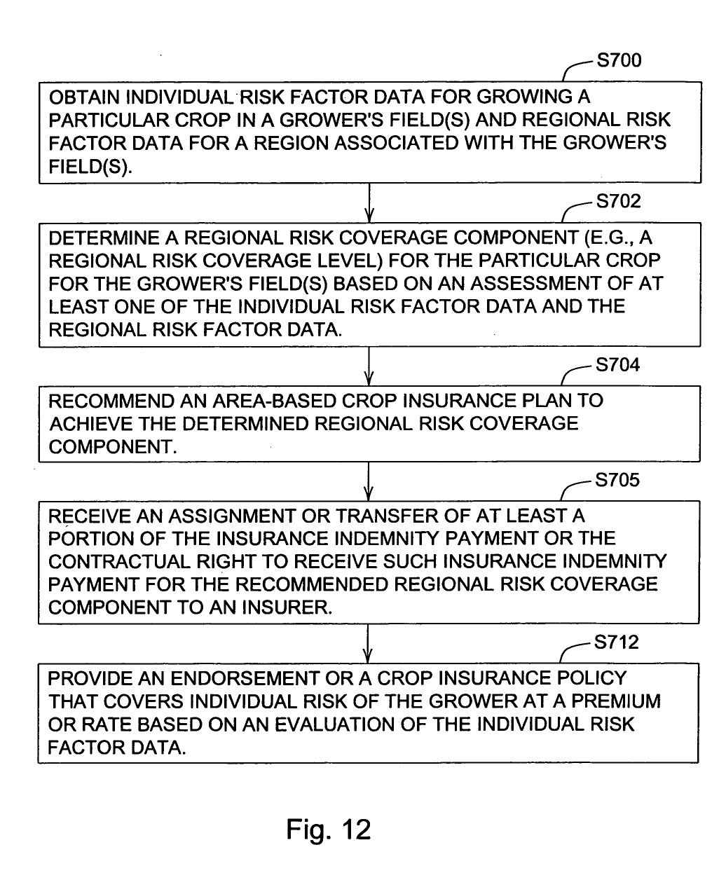

The method of FIG. 12 is similar to the method of FIG. 9, except step S708 of FIG. 9 is deleted and steps S705 and steps S705 and S712 are added to FIG. 12. Like reference numbers in FIG. 9 and FIG. 12 indicate like reference numbers.

In step S705, an insurer receives an assignment or transfer of at least a portion of the insurance indemnity payment (of the area-based crop insurance plan) or the contractual right to receive such insurance indemnity payment (of the area-based crop insurance plan) for the recommended regional risk coverage (e.g., area-based coverage meeting or exceeding a minimum regional risk coverage level) component. For example, the grower may assign all of the indemnity or merely a portion of the indemnity payment of a GRP, GRIP, GRP HRO crop insurance policy, or another area-based crop insurance policy to an insurer or a designee of an insurer.

Step S705 may be carried out in accordance with various techniques that may be applied individually or cumulatively. Under a first technique, an insurer, agent or another (person or entity) receives an assignment or transfer of all of the indemnity payment of the recommended area-based insurance plan that meets or exceeds a minimum regional risk coverage level to an insurer in exchange for that insurer issuing the offered endorsement or offered individual insurance policy as set forth in step S712. Under a second technique, an insurer, agent or another (person or entity) receives an assignment or transfer of a portion of the indemnity payment of the recommended area-based crop insurance plan that meets or exceeds a minimum regional risk coverage level to an insurer in exchange for that insurer issuing the offered endorsement or offered individual insurance policy as set forth in step S712. Under a third technique, an insurer, agent or another (person or entity) receives an assignment or transfer of a portion of the indemnity payment of the recommended regional insurance plan exceeding a minimum regional risk coverage level is assigned or transferred to an insurer in exchange for that insurer issuing the offered endorsement or offered individual insurance policy as set forth in step S712. Under a fourth technique, an insurer, agent or another person receives an assignment or transfer of a portion of the indemnity payment of the recommended regional insurance plan exceeding a minimum regional risk coverage level is assigned or transferred to an insurer, along with a monetary payment, secured loan, unsecured loan or execution promissory note, in exchange for that insurer issuing the offered endorsement or offered individual insurance policy as set forth in step S712.

In step S712, as noted above, the insurer provides an individual endorsement or individual crop insurance policy that covers the individual risk of the particular grower at a premium or rate based on the evaluation of the individual risk factor data (e.g., that obtained in step S700). The premium or rate may be determined based on the same or substantially similar consideration to that set forth in step S708 of FIG. 11.

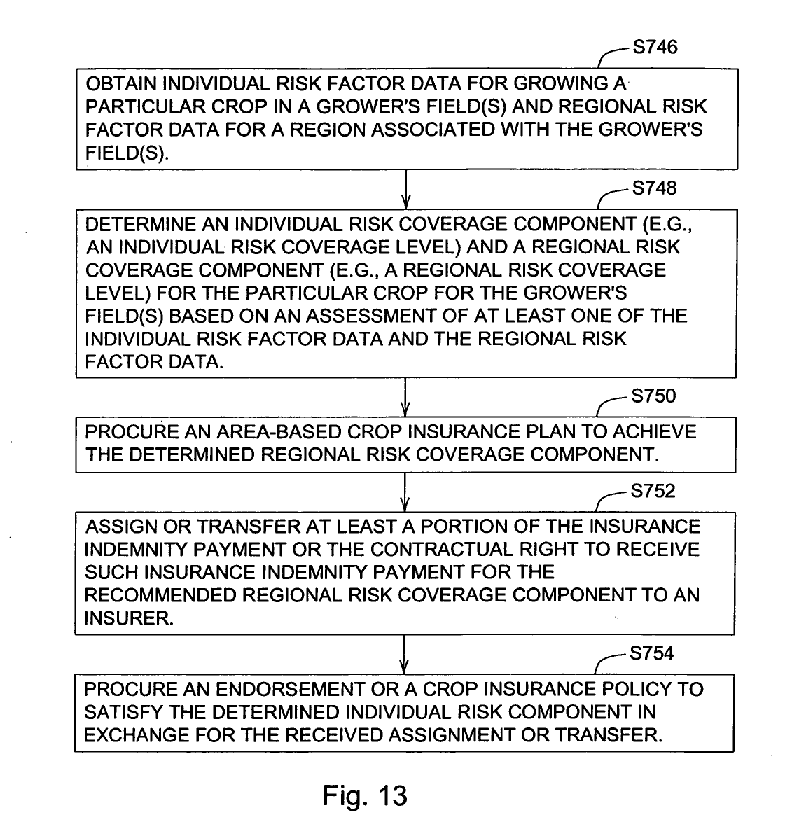

The method of FIG. 13 may be carried out by a grower, an agronomist, a consultant, or advisor to the grower, for example. The method of FIG. 13 begins in step S746. Although steps S746 and S748 may be executed by the grower data source 32 as described herein, the steps may be executed by any suitable data processing system, data processor, or computer.

In step S746, the grower data source 32 obtains individual risk factor data for growing a particular crop in a grower's field(s) and regional risk factor data for a region associated with the grower's field(s).

In step S748, the grower data source 32 determines an individual risk coverage component (e.g., an individual risk coverage level) and a regional risk coverage component (e.g., regional risk coverage level) for the particular crop for the grower's fields based on an assessment of at least one of the individual risk factor data and the regional risk factor data.

The assessment may consider the following factors: historic correlation between a grower's farm yield and a corresponding regional yield (e.g., county yield) for a particular crop, historic variance between a grower's farm yield and a corresponding regional yield a county, a correlation of soil characteristics of the grower's field to those of region (e.g., county), correlation of climate characteristics of the grower's field to those of the region (e.g., county), differences or variation in soil characteristics between the grower's field and the region, differences in elevation (e.g., average height about sea level) between the grower's field and the region, differences in irrigation or drainage between the grower's field and typical fields within a region or county, a distance of the grower's field with respect to a geographic center of the region, and distribution of the grower's fields or geographic dispersion of multiple grower fields within the region.

In one example, if the grower's yield of the grower's fields have a generally high correlation to the regional yield of a group of growers in the region (e.g., county), the grower may seek or be receptive to a greater level of regional risk coverage than individual risk coverage. However, if the grower's fields have a generally low correlation to the regional yield of a group of growers in the region, the grower may seek or be receptive to a greater level of individual risk coverage than regional risk coverage.

In another example, if the grower's soil characteristics of the grower's fields have a generally high correlation to the regional soil characteristics of a group of growers in the region (e.g., county), the grower may seek or be receptive to a greater level of regional risk coverage than individual risk coverage. However, if the grower's fields have a generally low correlation to the regional soil characteristics of a group of growers in the region, the grower may seek or be receptive to a greater level of individual risk coverage than regional risk coverage.

In another example, if the grower's climatic characteristics of the grower's fields have a generally high correlation to the regional climatic characteristics of a group of growers in the region (e.g., county), the grower may seek or be receptive to a greater level of regional risk coverage than individual risk coverage. However, if the grower's fields have a generally low correlation to the climatic soil characteristics of a group of growers in the region, the grower may seek or be receptive to a greater level of individual risk coverage than regional risk coverage.

In step S750, a grower procures an area-based crop insurance plan or regional crop insurance plan to achieve the determined regional risk coverage component, consistent with step S748.

In step S752, the grower assigns or transfers to an insurer at least a portion of the insurance indemnity payment or the contractual right to receive such insurance indemnity payment under the procured area-based crop insurance plan or regional risk coverage component.

In step S754, the grower procures an endorsement or crop insurance policy to satisfy the determined individual risk component in exchange for the received assignment or transfer of step S752.

Having described the preferred embodiment, it will become apparent that various modifications can be made without departing from the scope of the invention as defined in the accompanying claims.

We claim:

1. A method for providing risk protection to a grower of a crop, the method comprising:
obtaining individual risk factor data for growing a particular crop in a grower's field or fields and regional risk factor data for a region associated with grower's field or fields;
determining a regional risk coverage component for the particular crop for the grower's fields based on an assessment of at least one of the individual risk factor data and the regional risk factor data;
recommending an area-based crop insurance plan to achieve the determined regional risk coverage component; and
offering an endorsement or individual crop insurance policy that covers individual risk of the grower at a premium or rate based on an evaluation of the individual risk factor data.

2. The method according to claim 1 wherein the determining of the regional risk coverage component comprises a minimum regional risk coverage level associated with the grower.

3. The method according to claim 1 wherein the individual risk factor data comprises growing locations of the grower's field or fields and historic yield records for the particular crop associated with the growing locations.

4. The method according to claim 1 wherein the obtaining of the individual risk factor data is accomplished by a work vehicle equipped with a yield monitor to collect yield data.

5. The method according to claim 1 wherein the obtaining of the individual risk factor data and the regional risk factor data comprises accessing annual National Agricultural Statistics Service (NASS) county yield records to estimate a grower's yield with respect to a county yield.

6. The method according to claim 1 further comprising conducting a crop insurance transaction where at least a portion of the indemnity payment of the recommended area-based crop insurance plan is provided as consideration for the underwriting or issuance of the offered endorsement or individual crop insurance policy.

7. The method according to claim 6 wherein the conducting of the crop insurance transaction comprises assigning or transferring all of the indemnity payment of the recommended area-based insurance plan that meets or exceeds a minimum regional risk coverage level to an insurer in exchange for that insurer issuing the offered endorsement or offered individual crop insurance policy.

8. The method according to claim 6 wherein the conducting of the crop insurance transaction comprises assigning or transferring a portion of the indemnity payment of the recommended area-based crop insurance plan that meets or exceeds a minimum regional risk coverage level to an insurer in exchange for that insurer issuing the offered endorsement or offered individual crop insurance policy.

9. The method according to claim 6 wherein the conducting of the crop insurance transaction comprises assigning or transferring a portion of the indemnity payment of the recommended regional insurance plan exceeding a minimum regional risk coverage level is assigned or transferred to an insurer in exchange for that insurer issuing the offered endorsement or offered individual crop insurance policy.

10. The method according to claim 6 wherein the conducting comprises assigning or transferring a portion of the indemnity payment of the recommended regional insurance plan that meet or exceed a minimum regional risk coverage level to an insurer, along with a monetary payment or other consideration in exchange for that insurer issuing the offered endorsement or offered individual insurance policy.

11. A method for providing risk protection to a grower of a crop, the method comprising:
obtaining individual risk factor data for growing a particular crop in a grower's field or fields and regional risk factor data for a region associated with grower's field or fields;
determining a regional risk coverage component for the particular crop for the grower's fields based on an assessment of at least one of the individual risk factor data and the regional risk factor data;
recommending an area-based crop insurance plan to achieve the determined regional risk coverage component;
receiving an assignment or transfer of at least a portion of an insurance indemnity payment or a contractual right to receive such insurance indemnity payment for the recommended regional risk coverage component to an insurer; and
providing an endorsement or a crop insurance policy that covers individual risk of the grower at a premium or rate based on an evaluation of the individual risk factor data.

12. The method according to claim 11 wherein the regional risk coverage component comprises a minimum regional risk coverage level associated with the grower.

13. The method according to claim 11 wherein the individual risk factor data comprises growing locations of the grower's field or fields and historic yield records for the particular crop associated with the growing locations.

14. The method according to claim 11 wherein the obtaining of the individual risk factor data is accomplished by a work vehicle equipped with a yield monitor to collect yield data.

15. The method according to claim 11 wherein the obtaining of the individual risk factor data and the regional risk factor data comprises accessing annual National Agricultural Statistics Service (NASS) county yield records to estimate a grower's yield with respect to a county yield.

16. The method according to claim 11 wherein the receiving comprises the receiving of an assignment or transfer of all of the indemnity payment of the recommended area-based insurance plan that meets or exceeds a minimum regional risk coverage level to an insurer in exchange for that insurer issuing the offered endorsement or offered individual insurance policy.

17. The method according to claim 11 wherein the receiving comprises the receiving of an assignment or transfer of a portion of the indemnity payment of the recommended area-based crop insurance plan that meets or exceeds a minimum regional risk coverage level to an insurer in exchange for that insurer issuing the offered endorsement or offered individual insurance policy.

18. The method according to claim 11 wherein the receiving comprises the receiving of an assignment or transfer of a portion of the indemnity payment of the recommended regional insurance plan exceeding a minimum regional risk coverage level is assigned or transferred to an insurer in exchange for that insurer issuing the offered endorsement or offered individual insurance policy.

19. The method according to claim 11 wherein the receiving comprises the receiving of an assignment or transfer of a portion of the indemnity payment of the recommended regional insurance plan exceeding a minimum regional risk coverage level is assigned or transferred to an insurer, along with a monetary payment, or other consideration, in exchange for that insurer issuing the offered endorsement or offered individual insurance policy.

20. A method for providing risk protection to a grower of a crop, the method comprising:
obtaining individual risk factor data for growing a particular crop in a grower's field or fields and regional risk factor data for a region associated with grower's field or fields;
determining a regional risk coverage component for the particular crop for the grower's fields based on an assessment of at least one of the individual risk factor data and the regional risk factor data;
procuring an area-based crop insurance plan to achieve the determined regional risk coverage component;
transferring at least a portion of an insurance indemnity payment or a contractual right to receive such insurance indemnity payment for the recommended regional risk coverage component to an insurer; and
procuring an endorsement or a crop insurance policy that covers individual risk of the grower at a premium or rate based on an evaluation of the individual risk factor data.

21. The method according to claim 20 wherein the regional risk coverage component comprises a minimum regional risk coverage level associated with the grower.

22. The method according to claim 20 wherein the individual risk factor data comprises growing locations of the grower's field or fields and historic yield records for the particular crop associated with the growing locations.

23. The method according to claim 20 wherein the obtaining of the individual risk factor data is accomplished by a work vehicle equipped with a yield monitor to collect yield data.

24. The method according to claim 20 wherein the obtaining of the individual risk factor data and the regional risk factor data comprises accessing annual National Agricultural Statistics Service (NASS) county yield records to estimate a grower's yield with respect to a county yield.
